(19) United States
(12) Patent Application Publication
(10) Pub. No.: US 2004/0203939 A1
(43) Pub. Date: Oct. 14, 2004

(54) Character transcoding method for mobile phones

(76) Inventors: Wei Li, Shanghai (CN); Dai-Shui Ho, Taipei Hsien (TW); Shih-Kuang Tsai, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,655

(22) Filed: Nov. 7, 2002

(51) Int. Cl. H04Q 7/20; H04M 1/00; H04B 1/38

(52) U.S. Cl. 455/466; 455/556.1

(57) ABSTRACT

Characters encoded with a first character-encoding rule when inputted into a mobile phone are transformed to characters encoded with a second character-encoding rule. A document giving at least one character is first input into the mobile phone. An encoding rule of at least one character of the document is checked. All characters in the document are transformed to characters encoded in a second character-encoding rule if the checked character of the document is in a first character-encoding rule.

### BACKGROUND OF INVENTION

1. Field of the Invention

The present invention relates to a character transcoding method, and more specifically, to a character transcoding method that transforms characters encoded with a first character-encoding rule for a mobile phone to characters encoded with a second character-encoding rule.

2. Description of the Prior Art

With the advancement of communication technology, mobile phones have become ubiquitous as personal communications devices. A user of a mobile phone employs a mobile phone not only to call another person, but also to transmit short messages and even to send electronic mail.

In the first quarter of 2002, the number of global short messages sent by these users reached 50 billion, and in the foreseeable future, the number of short messages will be growing continuously. At the same time, however, problems associated with these messages often arise. Simplified characters are used in China, and the so-called GB encoding rule is employed as the character-encoding rule for simplified Chinese characters. On the other hand, traditional characters are used in Taiwan and Hong Kong, with the so-called Big-5 encoding rule employed as the character-encoding rule for traditional Chinese characters. The two different character-encoding rules, GB and Big-5, are not compatible. When users of mobile phones in China use their mobile phones to transmit short messages or electronic mail to mobile phones in Taiwan or Hong Kong, random codes or other garbled symbols or characters appear at the receiving end. This can be a source of embarrassment and confusion, and does not meet the needs of users of mobile phones in Taiwan, Hong Kong and China.

### SUMMARY OF INVENTION

It is therefore a primary objective of the present invention to provide a character transcoding method for a mobile phone to solve the abovementioned problem.

The present invention is a character transcoding method for transforming characters encoded with a first character-encoding rule when inputted into a mobile phone, to characters encoded with a second character-encoding rule. The method comprises the following steps:

(a) inputting into the mobile phone a document having at least one character;

(b) checking an encoding rule of at least one character of the document; and

(c) transforming all the characters of the document to characters encoded in a second character-encoding rule if the checked character of the document is in a first character-encoding rule.

The first character-encoding rule can be the GB or Big-5 encoding rules, and the second character-encoding rule can be a Unicode encoding rule.

The mobile phone of the abovementioned character transcoding method includes a checking module and a character encoding transforming module. In step (b) the checking module is used for checking an encoding rule of at least one character of the document. In step (c) the character encoding transforming module is used for transforming all the characters of the document to characters encoded in the second character-encoding rule. The character encoding transforming module can be a character-encoding rule reference table; in this case, in step (c), all of the characters of the document are transformed to characters encoded in the second character-encoding rule according to the character-encoding rule reference table.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a schematic diagram of a mobile phone of the present invention character transcoding method.

FIG. 2 is a flow chart of receiving a document via the mobile phone and transforming the characters of the document to characters encoded with a second character-encoding rule according to the present invention.

FIG. 3 is a flow chart of transforming the characters of the document that is input into a mobile phone to characters encoded with a second character-encoding rule according to the present invention, and then transmitting the transformed characters via the mobile phone.

### DETAILED DESCRIPTION

The largest message size of a short message is typically 160 characters in length. The receiving and transmitting of short messages is performed via automatic routing technology. In other words, a user mobile phone transmits a short message to a nearby server (such as a base station), the nearby server transmits the short message to an appointed server through a particular transmission pathway (frequently a wired network), and another user mobile phone receives the short message from the appointed server. The process of transmitting short messages makes use of a number of communication protocols to ensure that the short messages are transmitted correctly from the transmitting end to the receiving end.

The character structures (font types, character encoding, etc.) of languages throughout the world are different; therefore, the character-encoding rules of languages throughout the world are not the same. For instance, every English character typically needs only 7 bits for encoding purposes, but the more numerous Chinese characters require double bytes for encoding. To solve this problem, the International Standardization Organization (ISO), together with the Unicode Consortium, decided in 1991 to enact a general encoding rule suitable for character types throughout the world, and cooperated to develop the ISO 10646 international encoding rule and the Unicode encoding rule. The Unicode Consortium officially put forward the 3.0 version of the Unicode encoding rule in February 2000, which contains 49,194 characters from all of the languages throughout the world. These characters include 27,484 eastern Asian ideograms (the Han character set). The 3.0 version of the Unicode encoding rule corresponds with the ISO/IEC 10646-1:2000 standard. The 3.1 version of the Unicode encoding rule emerged in March 2001, which added 44,946 new characters, 42,711 of which are ideograms. With the previous characters of the 3.0 version of the Unicode encoding rule, the characters in the 3.1 version of the Unicode encoding rule total 94,140 characters, including more than 70,000 ideograms. The latest version of Unicode encoding rule is the 3.2 version of the Unicode encoding rule, promulgated in March of 2002. This version further contains another 1,016 new characters, but the ideograms are the same as those of the 3.1 version, which includes all of the Chinese characters from the Kangxi Dictionary, the Great Dictionary of Chinese Language, and the Hanyu Dacidian.

The Unicode encoding rule is the universal character-encoding standard, the intent of which is to enable Internet users to peruse documents and software on the worldwide web, without concern for the character-encoding rule used. In other words, if a programmer builds an English website using the Unicode encoding rule, a Russian Internet user can still read the text of this site by setting the character set of the browser. The present invention character transcoding method is based on the concept of the Unicode encoding rule to transform characters encoded with a first character-encoding rule when input into a mobile phone, to characters encoded with a second character-encoding rule.

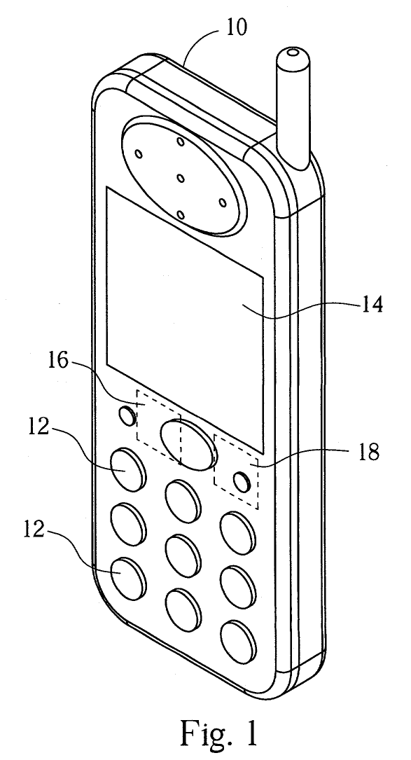

Please refer to FIG. 1. FIG. 1 is a schematic diagram of a mobile phone 10 of the present invention character transcoding method. The mobile phone 10 comprises a plurality of buttons 12 that are used to input into the mobile phone a short message or electronic mail message having at least one character. The mobile phone 10 also includes a liquid crystal display 14 for displaying text, a checking module 16 for checking the character-encoding rule of the character input into the mobile phone 10, and a character encoding transforming module 18 for transforming at least one character encoded with a character-encoding rule in the short message or electronic mail to at lease one character encoded with another character-encoding rule.

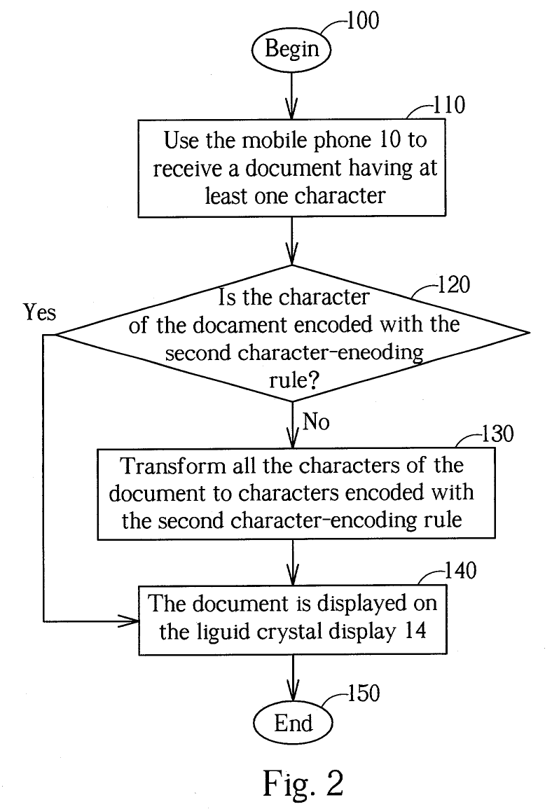

Please refer to FIG. 2. FIG. 2 is a flow chart of receiving a document via the mobile phone 10 and transforming the characters of the document to the characters encoded with the second character-encoding rule according to the present invention. In FIG. 2, the first character-encoding rule can be GB, Big-5, HZ code, or any other type of character-encoding rule, and the second character-encoding rule employs the Unicode encoding rule. The present invention character transcoding method comprises the following steps:

Step 100: Begin.

Step 110:

Use the mobile phone 10 to receive a document having at least one character (the document can be a short message or an electronic mail message).

Step 120:

Use the checking module 16 in the mobile phone 10 to check at least one character in the received document. If the checked character is encoded with the second character-encoding rule, the procedure goes to step 140; otherwise the procedure goes to step 130.

Step 130:

Use the character encoding transforming module 18 in the mobile phone 10 to transform all the characters in the received document to characters encoded with the second character-encoding rule.

Step 140:

At least one character of the document is displayed on the liquid crystal display 14.

Step 150: End.

In step 130 the present invention character transcoding method uses the hardware of the character encoding transforming module 18 in the mobile phone 10 to implement character transformation of the received document. However, the character transformation can also be carried out in software. That is, the character encoding transforming module 18 in the mobile phone 10 can be replaced with a character-encoding rule reference table, and the characters in the received document can be transformed to characters encoded with the second character-encoding rule according to the character-encoding rule reference table in the mobile phone 10.

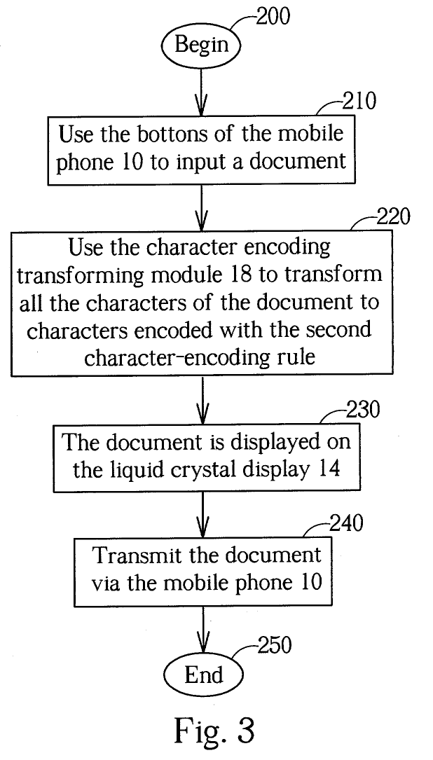

Please refer to FIG. 3. FIG. 3 is a flow chart of transforming the characters of a document, which has been input into the mobile phone 10, to characters encoded with the second character-encoding rule according to the present invention. The transformed characters are then transmitted via the mobile phone 10. The method comprises the following steps:

Step 200: Begin.

Step 210:

Use the plurality of buttons on the mobile phone 10 to input a document having at least one character (the document can be a short message or an electronic mail message). The characters so input are encoded with a first character-encoding rule.

Step 220:

Use the character encoding transforming module 18 in the mobile phone 10 to transform all of the character in the document to characters encoded with the second character-encoding rule.

Step 230:

At least one character of the document is displayed on the liquid crystal display 14.

Step 240: Transmit the document having the characters encoded with the second character-encoding rule via the mobile phone 10.

Step 250: End.

As previously mentioned, in step 220 the present invention character transcoding method uses the hardware of the character encoding transforming module 18 in the mobile phone 10 to implement the character transformation, but this transformation can also be carried out in software by way of a character-encoding rule reference table.

In the above flow charts of FIG. 2 and FIG. 3, the first character-encoding rule could be the Unicode encoding rule, and the corresponding second character-encoding rule could be GB, Big-5, HZ code, or any other type of character-encoding rule. In other words, in order to comply with different design considerations of the various types of mobile phones, the present invention character transcoding method not only transforms characters encoded with GB encoding rule (or Big-5, HZ code) to characters encoded with the Unicode encoding rule, but may also transform encoded with the Unicode encoding rule to characters encoded with GB encoding rule (or Big-5, HZ code). This can occur with the characters in received documents, as well as characters input into the mobile phone 10.

In contrast to the prior art, the present invention character transcoding method transforms characters encoded with a first character-encoding rule when input into a mobile phone, to characters encoded with a second character-encoding rule, and so is able to effectively solve the prior problem of random codes and garbled information that can otherwise occur because of the different character-encoding rules used by the receiving end and the transmitting end when exchanging a short message or an electronic mail message.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A character transcoding method for transforming characters encoded with a first character-encoding rule when input into a mobile phone, to characters encoded with a second character-encoding rule, the method comprising the following steps:
(a) inputting a document into the mobile phone, wherein the document comprises at least one character;
(b) checking a character-encoding rule of at least one character in the document; and
(c) transforming all the characters of the document to characters encoded with the second character-encoding rule if the checked character in the document is encoded with the first character-encoding rule.

2. The method of claim 1 wherein the mobile phone comprises a checking module, in step (b) the character-encoding rule of at least one character in the document being checked by the checking module.

3. The method of claim 1 wherein the mobile phone comprises a character-encoding rule reference table, in step (c) the characters in the document being transformed to characters encoded with the second character-encoding rule according to the character-encoding rule reference table.

4. The method of claim 1 wherein the mobile phone comprises a character encoding transforming module, in step (c) all the characters in the document being transformed to characters encoded with the second character-encoding rule by the character encoding transforming module.

5. The method of claim 1 wherein the first character-encoding rule is a Big-5 encoding rule for Chinese characters.

6. The method of claim 1 wherein the first character-encoding rule is a GB encoding rule for Chinese characters.

7. The method of claim 1 wherein the first character-encoding rule is a HZ encoding rule for Chinese and ASCII characters.

8. The method of claim 1 wherein the second character-encoding rule is a Unicode encoding rule.

9. The method of claim 1 wherein the mobile phone comprises a display for displaying the transformed characters encoded with the second character-encoding rule.

10. The method of claim 9 wherein the display is a liquid crystal display.

11. The method of claim 1 wherein the document is an electronic mail.

12. The method of claim 1 wherein the document is a short message for a short message service (SMS).

13. The method of claim 1 wherein the mobile phone comprises a plurality of pushbuttons, in step (a) the document being inputted into the mobile phone through the pushbuttons.

14. The method of claim 1 further comprising the following step:
in step (a), inputting the document through wireless communications.

15. The method of claim 1 further comprising the following step:
after performing step (c), transmitting the document encoded with the second character-encoding rule to another mobile phone through wireless communications.

16. The method of claim 1 wherein the first character-encoding rule is a Unicode encoding rule.

17. The method of claim 1 wherein the second character-encoding rule is a Big-5 encoding rule for Chinese characters.

18. The method of claim 1 wherein the second character-encoding rule is a GB encoding rule for Chinese characters.

19. The method of claim 1 wherein the second character-encoding rule is a HZ encoding rule for Chinese and ASCII characters.
